(19) United States
(12) Patent Application Publication
(10) Pub. No.: US 2003/0046207 A1
(43) Pub. Date: Mar. 6, 2003

(54) Participant voting system and method for creating a diversified investment fund

(76) Inventors: Andrew Torre, San Francisco, CA (US); Samir Shah, Bethesda, MD (US); Bashir Wada, San Francisco, CA (US)

Correspondence Address: Philip H. Albert, Townsend and Townsend and Crew LLP, 8th Floor, Two Embarcadero Center, San Francisco, CA, 94111-3834, US

(21) Appl. No.: 09/729,910

(22) Filed: Dec. 4, 2000

(51) Int. Cl. G06F 17/60

(52) U.S. Cl. 705/36; 705/12

(57) ABSTRACT

A voting system and technique is disclosed for determining a selected subset of participants from a plurality of candidates wherein each of the participants receive an equitable ownership interest of an item in exchange for a contribution. According to the present invention, the voting system and its method is used to select investors to participate in an investment vehicle, wherein the investment vehicle characteristically has a potentially high venture capital-type ROI (“return on investment”). The system and method optimizes asset diversification to meet the needs of holders of large blocks of private equity.

### BACKGROUND OF THE INVENTION

This invention relates generally to a system and a method for establishing a diversified investment vehicle, and more specifically to a system and a method for selecting the participants of such a vehicle.

The number of venture-backed companies has increased over the last few years. From 1997 to 1998, for example, there was a 24% increase in invested venture capital in fledging companies. Correspondingly, an increased number of founders and senior executives who have established these companies have been compensated with relatively large equity ownership interests in the upstart companies which they have formed. Since these shareholders hold concentrated positions in privately held stock of a single venture capital-backed entity, the shareholders' wealth is non-diversified. Consequently, the holdings in equity are at risk because “all their eggs are in one basket.” Hence, many of these founders find themselves “stock rich but opportunity poor” as no financial vehicle exists to help entrepreneurs and holders of large blocks of stock benefit from their privately-held shares. Due to this “financial catch 22” currently faced by an increasing number of private equity rich entrepreneurs, there is a clear need for an investment vehicle which will permit entrepreneurs to invest in a venture capital-type environment in promising privately held entrepreneurial companies, while significantly reducing risk.

Present investment vehicles, such as mutual funds, are inadequate to meet the financial needs of such holders of large blocks of equity since they do not help either leverage the potential benefits from large quantities of stock or shield the shareholders from the risks associated with private equity. Although mutual funds provide diversification and liquidity, the funds are professionally managed and require money (rather than equity) to be exchanged for a share of such a mutual fund. Diversification refers to the pooling of money in a mutual fund such that the shareholders are able to spread their assets among many different securities, thus sharply reducing the risk of loss from problems with any one company or institution. Liquidity refers to the ability to redeem shares on any business day in exchange for money based on that day's closing price.

The inadequacies, however, of present investment vehicles, make them inaccessible to founders, entrepreneurs and senior executives, who have large private security holdings. First, these vehicles, such as mutual funds, are established by the fund manager. That is, the professional investment manager decides which securities to buy and sell for a particular fund. Entrepreneurs and senior executives who themselves are experts on a particular sector and its securities, need not rely on such a manager because they are generally more knowledgeable than the fund manager about the financial health and future opportunities of the companies comprising an investment fund.

Second, present investment vehicles generally do not accommodate private equity rather than money in exchange for shares of an investment fund. Third, present investment vehicles include companies which have already been offered to the public, thus excluding its investors from gains typical of venture-backed entities which offer their private equity for public sale. Lastly, existing investment vehicles are not structured for private securities which are heavily regulated and can not be bought and sold on an open market.

Therefore, there is a need in the art for an inventive system and method for selecting investors to participate in an investment vehicle, or the equivalent, wherein the investment vehicle characteristically has a potentially high venture capital-type ROI (“return on investment”), asset diversification and liquidity, to meet the needs of holders of large blocks of equity. The diversified investment funds allow founders and senior executives of private companies to use their own equity, rather than cash, to make VC-type investments. These investments are made using their own objectives and expertise. Furthermore, the present invention also allows private securities investors the opportunity to participate in the upside of other venture-backed companies, which is not generally offered to the public at-large. Due diligence performed by reliable third parties also mitigates risk and enhances the potential for high returns.

### SUMMARY OF THE INVENTION

The present invention provides a voting system and technique for determining a selected subset of participants from a plurality of candidates. Each of the participants receive an equitable ownership interest of an item in exchange for a contribution. Accordingly, in one embodiment, the present invention provides a system comprising a plurality of candidate inputs configured to receive into the voting system a plurality of preferences associated with each of the plurality of candidates, a plurality of parametric inputs configured to receive a plurality of parameters, and logic to determine the participants and a respective amount of the contribution by each of the participants according to the plurality of preferences and the plurality of parameters.

In another embodiment of the present invention, the voting system further comprises at least one parametric processor. The parametric processor coupled to receive the candidate inputs and parameters to generate a parametric output based upon the plurality of preferences and the plurality of parameters. Furthermore, the voting system includes a participant selector and an ownership determinator.

A better understanding of the nature and advantages of the present invention may be had with reference to the detailed description and drawings below.

### BRIEF DESCRIPTION OF THE DRAWINGS

FIG. 1 is a simplistic block diagram illustrating a voting system according to an embodiment of the present invention;

FIG. 2 is a diagram showing another embodiment of the present invention using an exemplary networked system;

FIG. 3 is a detailed block diagram illustrating the voting system of the present invention;

FIG. 4 is a flowchart showing an application using the present invention;

FIG. 5 is a diagram showing matrix representations used to select participants according to an embodiment of the present invention; and

FIG. 6 is a flowchart showing an exemplary method of selecting participants according to the present invention.

### DESCRIPTION OF THE SPECIFIC EMBODIMENTS

The following detailed description of specific embodiments, including preferred embodiments, reference the accompanying drawings that form part of this disclosure. The drawings illustrate examples of the embodiments and how to practice the invention. Without departing from the scope of the present invention, other embodiments may be used in place of those shown and described, and such substitutions should be apparent to one of ordinary skill in the art upon reading this disclosure.

A voting system and a method is herein described wherein a potential investor interested in acquiring an equitable ownership interest in a specific subject matter, such as an investment vehicle, real property, or a business venture, is selected to participate in exchange for the potential investor's unique contribution. A “contribution” refers to the money, property, or any asset that a candidate investor places at risk to obtain an ownership interest in the subject matter. An investor is selected to participate based upon certain criteria or parameters which are designed to optimize the subject matter's performance (i.e., financial success). It should be understood that the subject matter, such as an investment pool, may comprise of an aggregate of similar contributions (i.e., all are stock shares) or of mixed contributions (i.e., combination of property, stock, or any other asset).

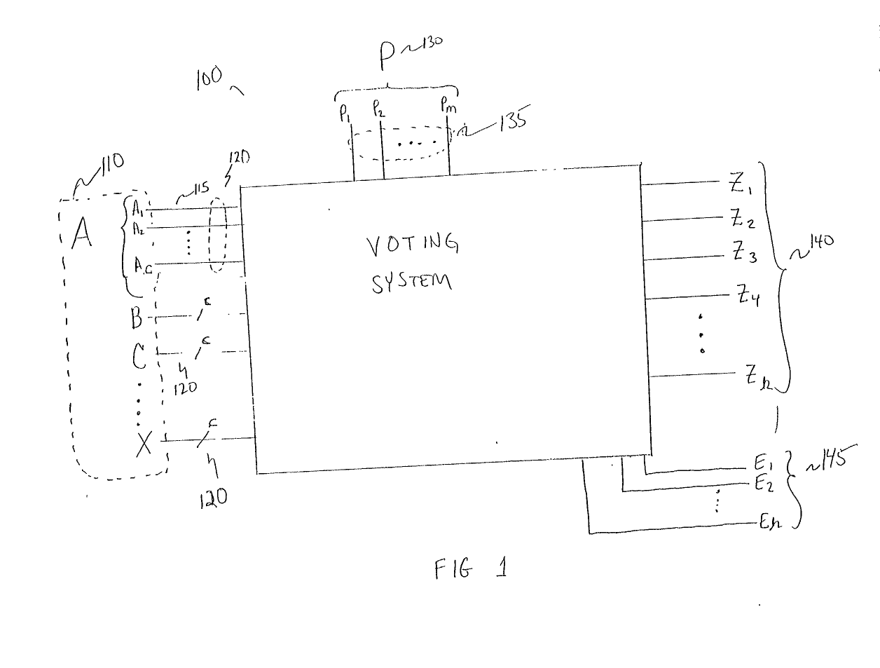

A specific embodiment of the present invention is shown in FIG. 1, a voting system 100 includes a number of inputs Ac-Xc 120 are available to a pool of prospective investors A-X 110, where each candidate investor 110 is permitted to access one or more inputs 115. Each single input 115 is configured to communicate with the system so as to present each candidate 110 with a “c” number of various options on the number of inputs 120 and to further convey each candidate's selected preferences on the number of inputs 120 to the system 100. The term “options” refers to a spectrum of choices that each of the candidate investors may choose. For example, each candidate will be presented with the opportunity to indicate preferences from the pool of prospective investors (i.e., options) those which the candidate believes will best ensure success of the subject matter. Each candidate also will be presented with the opportunity to invest varying amounts of the candidate's contribution into the subject matter. The term “preferences” refers to those options in which the investor candidate chooses to select and are sent to the system 100 via the number of inputs 120. Such preferences are those which each candidate investor believes will best benefit the subject matter as well as the candidate investor itself. Preferences also includes data or information required to form the subject matter, for example, as an investment vehicle. For instance, the candidates' preferences conveyed via the number of inputs 120 include a vote or a number of votes (from 0 to “V”) cast for each of the other prospective investors as well as the preferred amount of contribution each candidate 110 desires to invest. As an additional example, the preferences include the value of a candidate's shares as well as the number of shares a candidate wishes to invest. “Participants” refers to those prospective investors or candidate investors which have been finally selected to participate in the subject matter.

Additionally, a second set of inputs P 130 coupled to the voting system 100 are present to supply parameters (e.g., P1-Pm) 135 to the system 100. The parameters 135 guide the selection of constituent investors and thus influences how the subject matter is formed. The term “parameter” refers to a criterion or the criteria which governs the selection process. The parameters 135 include any real number (or numbers) as well as mathematical formulae for determining which candidates are the most suitable to acquire an ownership interest in the subject matter. In one embodiment, a subject matter manager (not shown), such as a fund manager, provides the parameters 135. If the subject matter is an aggregation of various private securities (i.e., an investment fund), for example, then each selected fund parameter is used to determine who will be invited to participate as well as how many corresponding shares of private equity will be pooled into the fund.

In operation, the voting system 100 accepts the number of inputs Ac-Xc 120 from prospective candidate investors A-X 110 and inputs P1-Pm 135 from a subject matter manager. The voting system 100 then uses preferences Ac-Xc communicated via the number of inputs 120 and parameters P1-Pm 135 to generate an optimized solution wherein the solution provides the best combination of constituent contributions E1-Ek 145 associated with each of the selected participants Z1-Zk 140. In one embodiment of the invention, each participant's ownership interest is also determined by the voting system 100.

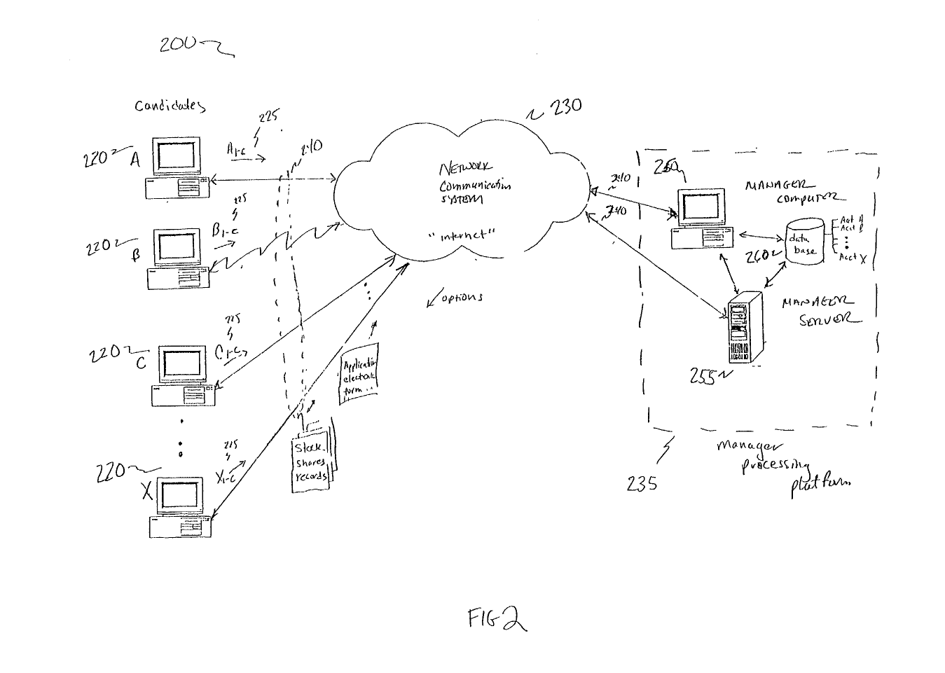

FIG. 2 depicts a diagram a specific embodiment of the present invention. As shown, the system 200 comprises one or more candidate computing devices A-X 220 configured to convey preferences Ac-Xc 240 and connected via a networked communication system 230, such as the Internet, to a manager processing platform 235. Each of the candidate computing devices 220 is associated with each of the potential investors and are configured to receive notices to participate in certain subject matters (e.g., investment fund announcements) and to provide each candidates' preferred co-participants and contributory amounts (i.e., according to the presented options). Although FIG. 2 depicts the use of the Internet for exchanging data, the present invention is not limited to the Internet, but includes any networking system or means to exchange information. Each candidate computing device 220 can be a desk top computer, a lap top computer, a personal digital device (“PDA”), a cell phone with processing and storage capability, or an equivalent device. A candidate computing device 220 typically includes a bus which interconnects major subsystems such as at least one processor, a system memory (typically RAM), an input/output (“I/O”) controller, an external device such as a display screen via a display adapter, ports (serial and/or parallel), an input device such as a keyboard or equivalent data entry means (e.g., voice-activated data entry means, keypads, touch-sensitive display screens, etc.), a fixed disk drive or the equivalent, such as ROM, and a floppy disk drive operative to receive a floppy disk, or the equivalent (i.e., FLASH memory card and adapter, etc.), and a CD-ROM device operative to receive a CD-ROM. Many other devices can be connected such as a user-pointing device (e.g., a mouse having a select button connected via a device port) or a modem connected via a data port.

Many other devices or subsystems with the respective computing devices (not shown) may be connected in a similar manner. Also, it is not necessary for each of the devices shown in FIG. 2 to be present to practice the present invention. The devices and subsystems (not shown) may be interconnected in different ways from that shown in FIG. 2. The operation of a computing device and its subsystems, such as that shown in FIG. 2, is readily known in the art and is not discussed in detail in this application. Software to implement the present invention may be operably disposed in either the candidate computing device's system memory, the manager processing platform or a combination thereof. In particular, it is stored in a storage medium such as fixed disk, floppy disk, memory card or CD-ROM.

A network interface system (not shown), such as a modem or an equivalent, provides a connection 240 to the manager processing platform, for example, via a land line or wireless data link, or to the Internet via a POP (“Point of Presence”). Such connections also includes, for example, TCP/IP (“Transmission Control Protocol/Internet Protocol”) connections, but other connections 240 and protocols are also possible, such as a SLIP/PPP (“Serial Link IP/Point-to-Point Protocol”) connection. Such connections 240 are between at least one of the candidate computing devices 220 and the manger processing platform 235 or between the candidate computing devices 220 themselves. One skilled in the art should understand that such protocols for establishing a connection to exchange data via the Internet are well known and need not be discussed herein. Alternatively, other types of network interface systems are well known in the art for providing the connection 240 from a computing device 220 or manager processing platform 235 to the network communication system 230. Lastly, the present invention may be implemented in the context of any network environment or within a single computing device.

The manager processing platform 235 of FIG. 2 includes a manager computing device 250 coupled to a manager server 255, where each of the manager computing device 250 and the manager server 255 are coupled directly to the network communication system 230 and to a manager database 260. In one embodiment of the manager processing platform 235, the manager server 255 is a computing device including software and means to service multiple requests and transactions with the prospective investors. In another embodiment, data and data structures representing each of the potential investor's accounts are stored and maintained on manager database 260. In yet another embodiment, the manager processing platform 235 selects the participants from a pool of candidates. For example, the server under control of proprietary software creates and maintains a certain fund, wherein a participant selector (described later) resides in the server and selects participants in a find according to the process disclosed herein. In yet another embodiment, the manager processing platform 235 is configured to oversee and to execute contribution swaps (e.g., one-to-one private stock swapping) between candidate computing devices.

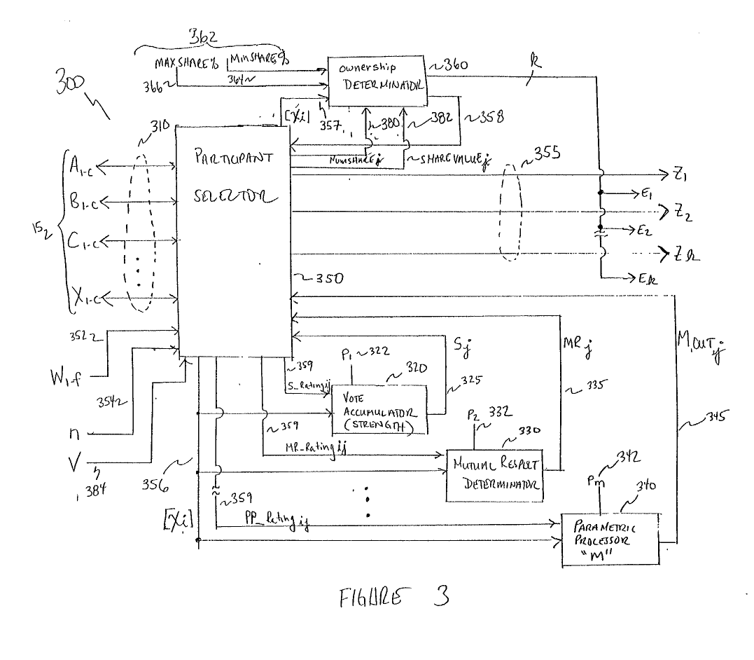

Another specific embodiment of the voting system 300, as shown in FIG. 3, includes a number of parametric processors, such as a vote accumulator 320, a mutual respect determinator 330, and a parametric processor “M” 340, whose functionality is determined by, for example, a fund manager. Also included is a participant selector 350 and an ownership determinator 360. Each of the parametric processors are coupled to receive the tentative participant information “xi” 357 from the participant selector 350 and are coupled to further provide the participant selector 350 with the respective parametric processor outputs. The tentative participant information “xi” 357 represents which candidates are tentatively selected to participate and, for example, is comprised of a subset of selected candidates “xi” (for candidates i to n) as is described below in the context of the participant selector 350.

Each of the parametric processors 320, 330 and 340 is adapted to receive one or more parameters to modify the processor's outputs for influencing the participant selection process. Furthermore, the parametric processors are configured to receive from the participant selector 350 the subset of selected candidates xi as well as respective ratings 359. The parametric processors, however, are neither required to receive parameters nor are they required to receive the subset of selected candidates xi 356 to provide for participant selection. In a specific embodiment, each of the parametric processors are cross-coupled (not shown) to one or more other parametric processors to exchange the respective processor outputs for determining which candidates will be selected as participants.

The participant selector 350 and the ownership determinator 360 are coupled to each other and are configured to further provide, for example, the selected participants Z1-Zk 355 from the pool of prospective investors and each of the selected participants' ownership interest E1-Ek 356 in the subject matter. A more detailed description of the structure and functionality of the voting system 300 is described below.

The vote accumulator 320 is configured to receive parameter P1 322 as well as the rating 359 (e.g., S_Rating) and the subset of selected candidates xi 356. Additionally, the vote accumulator 320 is configured to provide the resulting strength scores Sj 325 to the participant selector 350. In operation, the vote accumulator 320 determines and provides the participant selector 350 each of the prospective investors' strength Sj 325, where strength is defined as, for example, the number of total votes a particular candidate receives from all of the other candidates. A certain candidate's strength is in part based upon the reputation of the underwriter who funds that particular candidate. Since underwriters generally perform “due diligence” evaluations to minimize risk in their own investments, a highly reputable underwriter that backs a certain candidate's company can serve as an indicator of that candidate's potential success. Thus, it is expected that securities backed by underwriters having relatively higher reputations are associated with a higher strength rating than securities backed by underwriters having relatively lower reputations.

In one embodiment, the vote accumulator 320 employs strict voting wherein each candidate only votes for other candidates, thus excluding itself. In another embodiment, each candidate casts only a single vote for any one of the other potential investors. In yet another embodiment, the vote accumulator 320 employs cumulative voting wherein each candidate casts more than one vote for each of the other candidates, up to a predetermined vote limit. In a particular aspect of the vote accumulator 320, parameter P1 322 provides the maximum vote limit (e.g., “V” as described below in connection with Equation 1) that each candidate may cast. The vote accumulator 320 uses V to test each of the candidates votes cast to verify that the number of votes cast does not exceed the limit V. The following illustrates the operation of an exemplary vote accumulator: if there are 3 potential investors, such as A, B, and C, candidate A may receive 5 votes (3 votes from B, 2 votes from C), candidate B may receive 3 votes (2 votes from A, 1 vote from C), and candidate C may receive 1 vote (1 vote from A, 0 votes from B). In this example, the relative strength of candidates A, B, and C is related to the 5, 3, and 1 votes, respectively, where A is the strongest candidate for selection given a vote limit of 3.

The mutual respect determinator 330 functions to establish each of the prospective investors' degree of mutual respect MRj with each of the other selected investors. The mutual respect determinator 330 is configured to receive parameter P2 332 as well as the rating 359 (e.g., MR_Rating) and the subset of selected candidates xi 356. Additionally, the mutual respect determinator 330 is configured to provide the resulting mutual respect scores MRj 335 to the participant selector 350. In one aspect of the mutual respect determinator 330, parameter P2 332 provides, for example, an arithmetic operator such as addition to determine the mutual respect rating between participants. The degree of mutual respect represents the “mutual compatibility” which participants, if selected, share as joint owners in the subject matter.

Mutually compatible participants generally have similar risk tolerances and expect to benefit from investing in each other's contributions. For example, candidates owning private equity in corporations in a certain sector, such as the computer networking industry, generally are well informed as to not only their own corporation's financial condition, but are well aware of the other corporations' equity valuations associated with the other potential investors. Candidates in a certain sector are also familiar with the risks associated within the industry which they reside. Hence, a high level of mutual respect amongst all selected participants reflects the collective investors' desire to have each of the other participants collaborate in the risk management aspect of the vehicle provided by the present invention. Accordingly, the success of the subject matter and the benefits reaped therefrom, are in part based upon mutually compatible participants.

Mutual respect is expressed, for example, as an aggregation of votes cast between two or more selected investors. That is, mutual respect is the number of total votes cast amongst mutually compatible participants relative to the other investors. In one embodiment, the mutual respect determinator 330 evaluates votes which each recipient receives from the other participants, if each is selected, and then generates various outputs MRj 335 reflecting the different levels of mutual respect amongst the potential investors.

Returning to the previous example, where the 3 individual potential investors A, B, and C each receive 5, 3, and 1 votes, respectively, the mutual respect determinator considers and determines the following: First, although selected candidate C did cast a vote for selected candidate B, B did not cast a vote for C. Consequently, the relative mutual compatibility, or “mutual respect,” between B and C is low. Alternatively, candidates A and B exchange a total of 5 votes (2 votes from A to B, 3 votes from B to A), which is more than any other pair-combination (e.g., A-B, A-C and B-C).

In another embodiment, the mutual respect determinator 330 assigns a mutual respect rating, for example, to each pair-combination by summing the mutual votes cast. For example, A-B has a mutual respect of 5 (2 votes from A to B, 3 votes from B to A), A-C has a mutual respect of 4 (2 votes from A to C, 2 votes from C to A) and B-C has a mutual respect of 1 (1 vote from C to B, 0 votes from B to C). Thus, the mutual respect amongst A and B is relatively high and A and B most likely will be mutually compatible as joint owners in the subject matter rather than candidates B and C. It should be understood that mutual respect need not necessarily be represented by the votes exchanged between pairs of participants, although if each of the participants in the pair is selected to participate, then mutual respect may be described as the total votes exchanged between participant “i” and participant “j.”

In an alternative embodiment of one of the parametric processors, a parametric processor “M” 340 is coupled to receive the rating 359 (e.g., PP_Rating) and the subset of selected candidates xi 356. Additionally, the parametric processor “M” 340 is also configured to receive a parameter Pm 342. Parametric processor “M” 340 is configured to operate as determined, for example, by the subject matter manager and is configured further to provide its output to the participant selector 350.

In a specific embodiment of the participant selector 350, the participant selector is coupled to receive the preferences Ac-Xc 310 from the prospective candidate investors A-X 315 and is further coupled to at least one of the parametric processors for receiving the respective processor outputs. An exemplary participant selector is also configured to receive parameters V 384, W1-Wf 352 and “n” 354 to respectively set the number of votes (i.e., preferences) each candidate is permitted to cast, the weighting of each parametric processor's outputs in determining the selected participants and the number of maximum participants in the subject matter. The participant selector 350 is configured to provide the ownership determinator 360 with the tentative participant information “xi” 357, which represents which candidates are tentatively selected to participate and to output the final selection of participants 355. A “tentative participant” are those candidates who provide an optimal solution, but are yet tested to determine whether their associated contributions meet certain criteria. Such tentative participant information 357 can be represented by selected candidates xi. A specific embodiment of a participant selector is described in detail below.

In one embodiment, an ownership determinator 360 is configured to receive a diversification range (i.e., target range) and functions to limit each candidate investor's contribution amount to that range. The ownership determinator 360 is configured to communicate information with the participant selector 350. The determinator 360 receives tentative participant information 357 from the selector and provides rejected participant information 358 if a participant fails to meet criteria set, for example, by a subject matter manager. Furthermore, the ownership determinator 360 is configured to receive parameters 362 for establishing a diversification range, such as minimum and maximum contribution limits.

The ownership determinator functions 360 to ensure that the combined constituent ownership interests of the subject matter is optimized to provide, for example, a well-diversified investment fund. Otherwise, if some participants contribute a negligible amount into a particular subject matter, then the benefits realized from an “event” corresponding to a specific contribution would be negligible as well. Likewise, if the subject matter is heavily concentrated in a few contributions, then the benefits from the subject matter is at an increased risk. An event is a change in the nature of a particular contribution which allows the selected participants to share in the benefits reaped from such a change. For example, in an investment fund comprising blocks of private securities, when one of the many contributions goes from a private to public status or is acquired, then the increased value in equity is then shared amongst all the other participants. By way of another example, consider three participants such as D, E, and F who each own residential real property. If participant F's property is later subject to an “event” (i.e., zoned “commercial”) after the participants have been selected, then D and E will share in the benefits with F in F's increased property value, assuming the property value increases after such a re-zoning event.

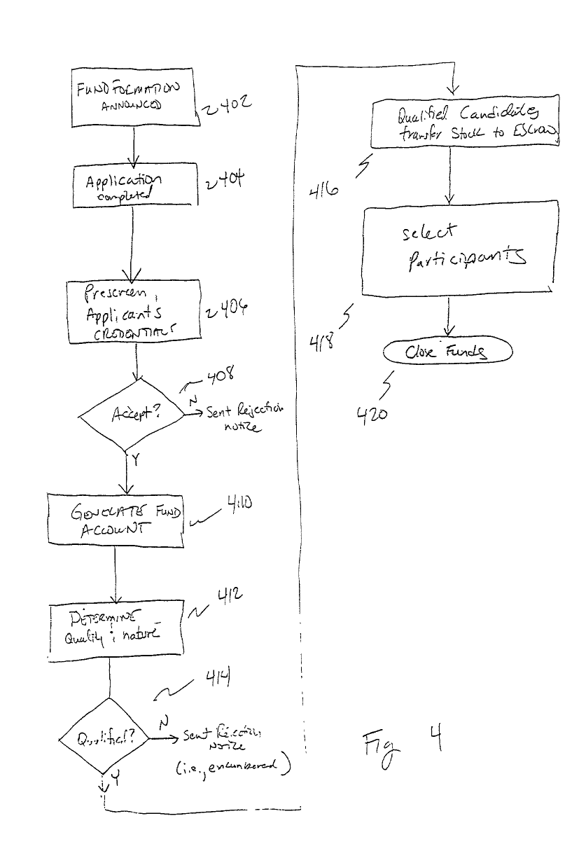

Operation of an exemplary voting system 300 is described below as applied in the formation of an investment vehicle comprised of blocks of private securities. Prior to the selection process, each pre-candidate (i.e., individuals or other legally recognized entities invited to qualify as a candidate) and their respective contributions are processed as to meet a quantum level of suitability as a potential participant. Referring to FIG. 4, an announcement is made inviting certain pre-candidates to participate in a fund formation 402. A pre-candidate first provides information necessary to evaluate whether it may qualify as a candidate in a fund formation. Such information is provided by way of an investor application 404 in the form of a hard-copy version or a hypertext document (i.e., web page residing in the manager server), an electronic mail application, or other forms known in the art. In one embodiment, the information is communicated from a candidate computing device to the manager processor platform for further consideration.

At the manager processing platform, pre-formation activities are executed and the results maintained for later processing. The manager computing device, operating with proprietary manager program code, pre-screens a pre-candidate's credentials against pre-determined metrics at 406. In step 408, the manager computing device determines whether a pre-candidate may qualify as a candidate. If qualified, an account is generated by the manager computing device at step 410 which is associated with each of the allowed candidates. Additionally, the accounts are maintained in the manager database. If rejected, the manager computing device generates a rejection notification (i.e., e-mail) sent to the rejected pre-candidate's computing device via the networked system (e.g., Internet).

The manager processing platform operates further to communicate and to exchange data with the fund manager. The fund manager augments pre-screened candidate information maintained in the manager database or server as required. The fund manager determines the quality and nature of each of the candidates contributions at 412. For example, the fund manager reviews the nature of the potential investor's securities regarding associated stock purchase agreements, corporate by-laws, shareholder rights agreement, etc. to determine whether the private equity is encumbered and thus not acceptable to participate at 414. Information regarding the quality and nature of the private equities are then provided to the manager processing platform. The platform then coordinates a securities transfer from all accepted candidates to a respective escrow account at 416.

In the pre-formation process, and as a condition of possibly participating in a future investment fund, candidates have agreed to transfer title of their contributions to an escrow account. Upon “closing” of the fund, a particular share amount is transferred from the escrow account into the investment vehicle. The share amounts transferred need not be the total share amount which each of the candidates desires to invest. Rather, as part of the fund creation and diversification process, the manager processing platform determines how many shares will join the fund. The unused shares remain in escrow and available for future fund formations or for withdrawal, according to the candidate's wishes. In one embodiment of escrow implementation, data representing and associated with the various escrow accounts are generated and maintained on an escrow server under third party control. Once the candidates have been chosen, the next step is to select which candidates will participate in the fund at 418. The fund closes after all the candidates have been selected at 420. Upon approval to do so, the manager processing platform coordinates and executes the transfer of stock certificates (or electronic representations thereof) from escrow to the investment fund.

Referring back to FIG. 3, a specific embodiment of the voting system 300 used to select participants is described below in the context of an investment fund. An exemplary voting system 300 includes a number of parametric processors configured to receive parameters P1-Pm which are provided to the respective processors by a fund manager. These processors govern the fund formation process by, for example, optimizing overall strength and mutual respect of each of the selected participants. Each parameter is described further below in conjunction with the respective processor.

As shown in FIG. 3, an exemplary vote accumulator 320 is configured to receive the rating 359 (e.g., S_Ratingij), the parameter P1 322 and the subset of selected candidates xi 356 to determine the relative strength of each of the candidates. In particular, the vote accumulator 320 determines the degree of strength given to each candidate “j” by all other candidates “i” (where j is 0 to “N”, N representing the number of candidates).” For example, if each candidate is asked to allocate no more than a total of V points, the following relationship holds true for all the total votes cast by each candidate i:

$${\sum }_{j = 1}^{N} {S\_Rating}_{ij} = V \qquad Equation 1$$

where V represents the total votes available to a particular candidate to cast in favor of other candidates.

The total number of points V is parameter P1 322 and parameter V 384, set by the fund manager. The total number V, for example, can be set to 100 points. Thus, each candidate may distribute cumulatively (i.e., voting for another with more than 1 point) its 100 points over the pool of other potential investors. In another aspect of the vote accumulator, V is set to 1 to effect a “one candidate, one vote” implementation (i.e., non-cumulative).

The degree of strength of each candidate j is determined, relative to each of the other candidates, for example, by summing the votes cast by each candidate i for candidate j, regardless of whether the candidate is eventually selected to participate. The strength score (e.g., degree of strength) of each candidate j is expressed as Sj in Equation 2.

$$Sj = {\sum }_{i = 1}^{N} ( {S\_Rating}_{ij} ) \qquad Equation 2$$

The higher the point value assigned to another candidate by candidates i inherently attaches a higher level of strength to that particular candidate's private securities. Hence, the candidates and corresponding contributions receiving higher strength levels reflect the collective view that those equities are more attractive investments relative to those having lower levels of strength.

An exemplary mutual respect determinator 330 is configured to receive the parameter P2 332, the rating 359 (e.g., MR_Ratingij) and the subset of selected candidates xi 356, wherein the mutual respect determinator 330 operates to determine the relative mutual compatibility between each of the selected candidates and the other selected candidates. Each participant generally prefers to participate in a fund comprising other participants that they rated highly. The mutual respect determinator 330 functions to determine the compatibility between participants rather than pre-selected candidates by evaluating the mutual respect rating (i.e., MR_Ratingij) of each selected participant “j” which has been assigned by all of the other selected participants “i.” In a specific embodiment of the mutual respect rating, the value of each MR_Ratingij is the same as the value of each S_Ratingij (i.e., the same number of votes cast for a particular candidate or participant by the other candidates or participants), although the values need not be the same to practice the present invention.

Parameter P2 332, for example, provides the mutual respect determinator 330 with an arithmetic operator for determining a mutual respect rating, such as the sigma operator (i.e., addition) of Equation 3. Unlike the strength score, which reflects the strength of each candidate regardless whether that candidate is selected, the mutual respect score (i.e., degree of mutual respect) reflects the points exchanged between only those candidates selected to participate in the subject matter. If each selected candidate is asked to allocate a total of V points, the following Equation 3 reflects a mutual respect score assigned to a candidate j as the sum of votes it receives from candidates i that were selected to participate in the pool.

$$MRj = {\sum }_{i = 1}^{N} ( {x}_{i} * {MR\_Rating}_{ij} ) \qquad Equation 3$$

The mutual respect determinator output 335 is configured to couple the participant selector 350 to the mutual respect determinator 330 and provides values of MRj associated with each candidate j (for j from 1 to N) for further processing, as explained below.

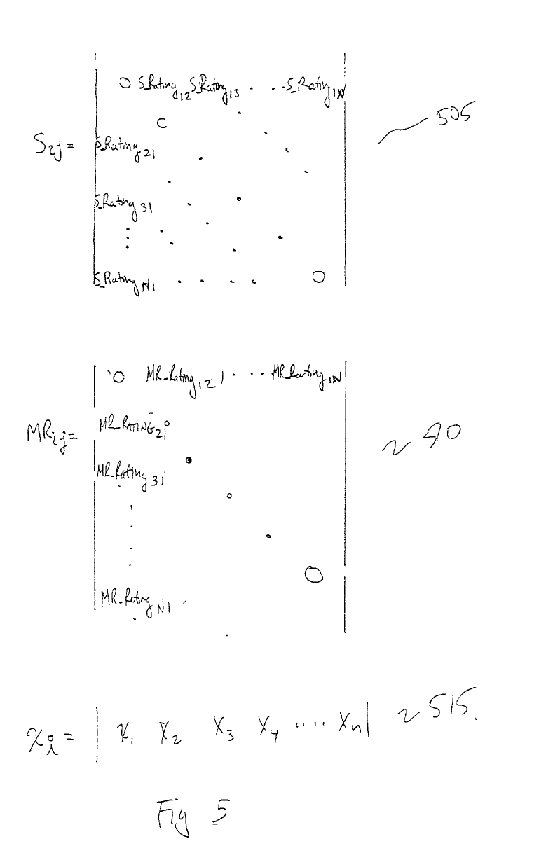

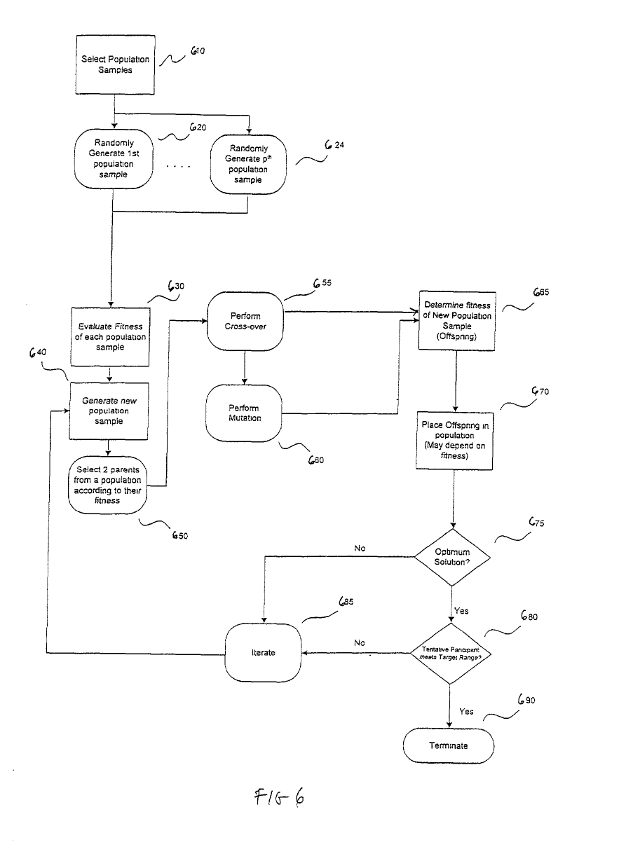

Other parametric processors “M” 340 are configured to accept preferences from candidates A-X 310, the parameter Pm 342 and a subset of selected candidates “xi.” Parametric processors M 340 are configured further to provide its output 345 to the participant selector for selecting participants from the pool of potential investors. Like other parameters, Pm 342 is provided by the fund manager to modify the selection process as desired. It should be understood that the fund manager can determine how each of the parametric processors “M” 340 are to function (i.e., according to a mathematical relationship) for optimizing the selection process. The participant selector 350 is configured to receive outputs from the parametric processors, such as Sj 325, MRj 335, Mout 345, as well as parameters V 384, W1-Wf 352 and n 354, and the preferences Ac-Xc 310 from the prospective candidate investors A-X 315. The participant selector 350 uses the parametric processor outputs to select the fund participants from the pool of potential investors according to, for example, at least two objectives: First, participants should be selected such that the find has the greatest potential return, and second, participants should be selected so as to maximize the extent to which the participants rated each other highly (i.e., mutual compatibility). The first objective is achieved by including those candidates who have the highest levels of strength as discussed above, wherein the pool of potential investors are in the best position to evaluate the worthiness of each other's securities. The participant selector 350 determines the overall strength of all of the candidates (i.e., strength component [Sij]), where the overall strength is expressed as a strength rating component. As summed over all i's and j's, the overall strength is mathematically described in the following Equation 4, where Equation 4 is essentially Equation 2 summed over all j's.

$$[ Sij ] = {\sum }_{j = 1}^{N} {\sum }_{i = 1}^{N} ( {x}_{i} * {S\_Rating}_{ij} ) \qquad Equation 4$$

where xi is set to 0 if not selected or to 1 if selected. Participant Selector 350 operates to vary xi between 0 and 1 during the selection process for determining an optimized solution, as discussed further below in connection with FIGS. 5 and 6. In one embodiment, the overall strength component excludes strength ratings where i=j.

The second objective is achieved by including those participants who have the highest degree of mutual compatibility relative over all participants as discussed above. Thus, the fund is selected such that the mutual respect between all its participants is maximized. The overall mutual respect of all of the candidates (i.e., [MRij]) is expressed as a mutual respect component, summed over all i's and j's, as mathematically described in Equation 5, where Equation 5 is essentially Equation 3 summed over all j's.

$$[ {MR}_{ij} ] = {\sum }_{j = 1}^{N} {\sum }_{i = 1}^{N} ( {x}_{i} * {x}_{j} * {( MR\_Rating )}_{ij} ) \qquad Equation 5$$

Unlike the strength component, the mutual respect component reflects a score as determined from only those tentatively selected to participate. That is, the determination of MRij requires both values of xi and xj to be 1, whereas Sij requires only xi to have a value of 1. In one embodiment, the mutual respect component excludes mutual respect ratings where i=j.

In operation, the participant selector 350 maximizes the combined values representing the best solution. The best solution is the combination of candidate investors which optimizes the benefits (i.e., reduction of risk, enhancement of rewards, etc.) to each of the find participants. The following mathematical representation shown in Equation 6 illustrates an exemplary formula which the participant selector 350 uses to select participants Z1-Zk. The selector 350 determines whether a specific combination of candidates yields a maximized score representing the Objective of the fund, the Objective represented by the following:

Objective=[Sij]+[MRij] Equation 6

where [Sij] and [MRij] are determined according to Equations 4 and 5, respectively. In another embodiment of the participant selector 350, the objective formula to be maximized, includes weighting factors (i.e., W1, W2, . . . , Wf) 352 as shown in Equation 7.

Objective=W1*[Sij]+W2*[MRij] Equation 7

These weighting factors are any real valued number, whether positive or negative, and are used to assign more weight to a particular component so as to influence the participant selection process. For example, if W1 is set to 1 and W2 is set to 8, then the mutual respect component substantially drives the fund formation process by a factor of 8-to-1 because weighting factor W2 emphasizes its component by increasing its numeric score.

Another parameter, n 354, is supplied to the participant selector as a constraint. This parameter is set to balance portfolio diversification between dilution of benefits and unacceptable risks. If there are too many participants, each participant's increased value of their ownership interest Ek may be spread too thin. Conversely, if there are too few participants, then each participant's ownership interest Ek is susceptible to an unacceptable loss of value. The value n 354 thus restricts the total of participants as represented mathematically in following Equation 8:

$${\sum }_{i = 1}^{N} {x}_{i} \leq n \qquad Equation 8$$

In one aspect of the participant selector, parameter n 354 is provided by the fund manager.

The ownership determinator 360 is configured to receive data representing the tentative participants 356 (e.g., xi or x1, x2, x3 . . . xn, where xi=1 indicates tentative selection and xi=0 indicates tentative rejections) permitted to invest in the fund and is configured further to receive a number of preferences 310 from participant selector 350. The preferences 310 received include the amount of shares 380 (i.e., NumSharesj) each potential investor wishes to invest as well as the value of each of shares 382 (i.e., ShareValuej). Furthermore, the ownership determinator 360 is adapted to receive parametric values which, for example, are used to form a target range (i.e., a minimum and a maximum value). In one aspect of the ownership determinator, the target range is set by the fund manager. In another aspect, the target range is expressed as a range of percentiles from a minimum to a maximum percentage of the fund's total value.

The ownership determinator 360 operates to ensure that each participant's contribution is within a target range. If a tentative participant's contribution is either below a minimum share percentage 364 (i.e., MinShare %) or above a maximum share percentage 366 (i.e., MaxShare %), then the tentative participant is rejected. Otherwise, the tentative participant is selected to join in the fund. A minimum level of diversification is represented mathematically as shown in Equation 9, wherein each participant's contribution to the fund must be at least equal to the MinShare %. For each value of j from 1 to N, candidate j must meet the following criterion:

$${x}_{j} ( {NumShares}_{j} * {ShareValue}_{j} ) \geq MinShare \% * {\sum }_{i = 1}^{N} {x}_{i} ( {NumShares}_{i} * {ShareValue}_{i} ) \qquad Equation 9$$

Likewise, a maximum level of diversification is represented mathematically in Equation 10, wherein each participant's contribution to the fund must be less than or equal to the MaxShare %. For each value of j from 1 to N, candidate j must meet the following criterion:

$${x}_{j} ( {NumShares}_{j} * {ShareValue}_{j} ) \leq MaxShare \% * {\sum }_{i = 1}^{N} {x}_{i} ( {NumShares}_{i} * {ShareValue}_{i} ) \qquad Equation 10$$

Regardless of which of the two relationships fail in Equations 9 and 10, the rejection of a tentative participant activates the ownership determinator 350 to convey this information 358 (e.g., xi representing rejected tentative participants) to the participant selector so that a new tentative participant may be tested against the target range.

Once each of the tentative participants have met the target range criteria, then the participant selector 350 outputs the data indicating which of the candidates have been selected to participate in the investment fund, such as Z1-Zk 355. The fund is then “closed” as to new participants. Likewise, the ownership determinator 360 outputs data indicating each of the participants' amount of contribution E1-Ek 365 that is to be invested, where each contribution is expressed as a percentage. In one aspect, the contribution amounts are withdrawn from respective escrow accounts, upon find closure, for deposit into the fund.

A specific embodiment of the participant selector 350, and its operation, are discussed below in connection with FIGS. 5 and 6. The participant selector 350 is implemented in hardware, software or a combination thereof. For example, the participant selector is at least configured to store and to process data. The data storage means (not shown) in the selector may be a semiconductor memory device (e.g., EPROM), a computer storage medium (e.g., magnetic disk), or any other equivalent way to store data as known in the art. The selector 350 also includes at least a processor (not shown) for retrieving stored data (e.g., strength and mutual respect ratings) and for determining which candidates are most suited to participate given certain fund formation rules (i.e., mathematical equations).

In operation of an exemplary participant selector 350, the selector receives the strength scores (i.e., Sj) and the mutual respect scores (i.e., MRj) as determined by the vote accumulator 320 and the mutual respect determinator 330, respectively. Each candidate's investor participation status is mathematically represented in the exemplary participant selector 350 by variables xi for i=1 to n, where each variable x1, x2, x3 .. . xn is set to a value of either zero or one (depending on its status). For example, if xi=1, then candidate number i is chosen to be in the fund, and if xi=0 then candidate number i is not chosen to be in the fund. In one embodiment of the selector's data storage, values for the ratings and variables xi are stored in matrix form as shown in FIG. 5. FIG. 5 shows an exemplary form of representing the data described herein. For example, the strength associated with each candidate is represented in matrix 505, the mutual respect associated with each candidate is represented in matrix 510 and the data representing a possible solution associated with the selected participants is represented in matrix 515, where a candidate number xi chosen to be in the fund is represented by a 1.

An illustrative participant selector 350 is capable of using a variety of optimization processes to yield the best solution for selecting participants, such as hill climbing, tabu search and simulated annealing. In another embodiment, the selector 350 employs at least one genetic algorithm, or a variant thereof, to generate an optimum solution amongst other possible combinations of participants. In yet still another embodiment, the selector 350 uses a proprietary genetic algorithm Evolver™ manufactured by Palisade Corporation, New York, U.S.A. Genetic algorithms are well known in the art, and thus a skilled artisan should understand how to apply genetic algorithms to optimize fund formations in light of the following discussion.

FIG. 6 illustrates the application of a basic genetic algorithm as an example. The selector first selects a population of samples (i.e., chromosomes) at 610. From 620 to 624, a set of p solutions (i.e., samples) are randomly generated by the selector. In one aspect, the population samples are embodied in the form shown in FIG. 5 wherein each sample 515 is expressed by variables xi. Hence, each population sample is of the form:

|xi|=[x1 x2 x3 x4 x5 . . . xn]

where each solution includes values of zero and one. For example, in one solution where x1, x2 and x4 are selected and x3 and x5 are rejected, the chromosome-sample thus formed appears as follows:

|xi|=[1 1 0 1 0 . . . xn].

At 630, each solution p is evaluated to determine its fitness (i.e., whether it is the optimal solution of all possibilities). In an embodiment of the participant selector, the fitness of a specific sample is determined according to Equation 7 from above, which in turn is based upon Equations 4 and 5. In one aspect, the use of matrix mathematics is suitable to manipulate the data and its application in the present invention should be apparent to a skilled artisan. Thereafter, the selector's processor generates a new population sample (i.e., offspring) at 640, based upon the previous samples. At 650, two parent chromosomes from a population are selected according to their fitness (a higher degree of fitness is associated with a higher probability to be selected). Given two fit parent-samples, the acts of 655 and 660 are used to produce a new offspring sample. In 655, each parent exchanges a portion of its chromosome to form a new offspring (i.e., a new combination). For example, a sample A and a sample B contribute a portion of its chromosome at a crossover point, xco, which is randomly determined. Thus A contributes a portion of its chromosome in the form of a binary string from x(a)0 to x(a)co-1 to an offspring and B contributes a binary string from x(b)co to x(b)n to form a new offspring having binary strings from both parents.

At 660, the offspring is mutated. Mutation prevents all solutions in population from converging into a local optimum, rather than a globally optimized solution. Mutations modify the binary-encoded offspring by randomly changing values of xi (i.e., bits) from 1 to 0 or from 0 to 1. In one aspect of the mutation process, the mutation of an offspring need not occur after each cross-over operation.

The fitness of the new offspring is evaluated at 665 and is compared to the fitness of each of the population samples. In one aspect of 665, each of the new offspring is assigned a weighting which is proportional to its fitness. Such a weighting is used to determine whether to select this offspring as a parent in later offspring formations. For example, an offspring having a high fitness level (i.e., closer to an optimum solution) has a corresponding high weighting. A high weighting indicates that an offspring has a relatively high probability of being selected as a parent. Regardless, the new offspring is placed back in to the population at-large in 670 and is available for later selection as a parent. In one aspect of 670, an offspring having a fitness level below a pre-determined minimum may be discarded to ensure quick convergence upon an optimum solution.

At 675, the fitness of an offspring is compared relative to the last optimum solution to determine whether the offspring contains values of xi which provide select participants whose combined contributions are best suited for the fund. If it is not the best solution, then the participant selector continues in step 685 to determine the best solution. If it is the best solution, then each tentative participant's contribution is tested by the ownership determinator against the target range in step 680, as described above. If a tentative participant fails to meet the contribution amount criterion, the ownership determinator remits the set of participants having a rejected tentative participant for a new determination. The participant selector then solves for those participants which meet the optimum solution as well as the target range criteria. After an optimum solution has been determined, the participant selector terminates operation in step 690 by providing the participants which have been selected (Z1-Zk) and the corresponding amount of contributions (E1-Ek).

The above description is illustrative and not restrictive. Many variations of the invention will become apparent to those of skill in the art upon review of this disclosure. For example, the voting system and method described herein and shown in the figures generally operates to select participants in an investment fund. However, the present invention also has utility in selecting participants in an investment fund wherein the investors exchange rights to real or intellectual property for an equitable ownership interest in the entire pool of real estate or assigned patent rights. Furthermore, potential candidate shareholders can similarly use the present invention to select those shareholders in a corporation or joint business venture. For example, if a private corporation offers shares to a pool of candidates, those selected to become participants may be determined according to the voting system and method disclosed in the present invention. The scope of the invention should, therefore, be determined not with reference to the above description, but instead should be determined with reference to the appended claims along with their full scope of equivalents.

What is claimed is:

1. A voting system for determining a selected subset of participants from a plurality of candidates, each of the participants having an equitable ownership interest of an item to exchange for a contribution associated with each participant, the system comprising:
a plurality of candidate inputs configured to receive into the voting system a plurality of preferences associated with each of the plurality of candidates;
a plurality of parametric inputs configured to receive a plurality of parameters; and
logic to determine the participants according to the plurality of preferences and the plurality of parameters.

2. The system of claim 1, further comprising logic to determine a respective amount of the contribution by each of the participants according to the plurality of preferences and the plurality of parameters.

3. The system of claim 1, further comprising at least one parametric processor, the parametric processor coupled to receive at least one of the plurality of parameters to generate a parametric output based upon the plurality of preferences and the at least one of the plurality of parameters.

4. The system of claim 3, wherein at least one of the parametric processors further comprises a vote accumulator, the vote accumulator configured to receive a tentative subset of participants and at least one of the plurality of parameters, wherein the vote accumulator includes logic to determine and to provide a strength score for each of the plurality of candidates.

5. The system of claim 4, where the strength score of each of the plurality of candidates is a total number of votes cast by a plurality of other candidates.

6. The system of claim 3, wherein at least one of the parametric processors further comprises a mutual respect determinator, the mutual respect determinator configured to receive a tentative subset of participants and at least one of the plurality of parameters, wherein the mutual respect determinator includes logic to determine and to provide a mutual respect score between each of the participants relative to each of the other participants.

7. The system of claim 6, where mutual respect between candidates is a number of votes mutually cast between each of the participants relative to each of the other participants.

8. The system of claim 1, further comprising a participant selector, the participant selector configured to receive a plurality of outputs from the plurality of parametric processors and a plurality of selector parameters, wherein the participant selector includes logic to determine and to provide the selected subset of participants having equitable ownership in the item.

9. The system of claim 8, wherein the participant selector is further configured to provide a tentative subset of participants.

10. The system of claim 8, wherein at least one of the plurality of selector parameters is a weighting factor.

11. The system of claim 8, wherein at least one of the plurality of selector parameters is a maximum number of participants.

12. The system of claim 8, wherein at least one of the plurality of selector parameters is a maximum number of votes available to each of the plurality of candidates.

13. The system of claim 8, further comprising an ownership determinator configured to receive a plurality of ownership determinator parameters and configured further to exchange information with the participant selector, wherein the ownership determinator includes logic to determine and to provide the pro rata equitable ownership interest of each of the number of participants, where each pro rata interest associated with each of the number of participants is within a diversification range.

14. The system of claim 13, wherein the plurality of ownership determinator parameters include a maximum ownership share limit and a minimum ownership share limit.

15. The system of claim 1, wherein the plurality of preferences include a plurality of votes cast by each of the plurality of candidates for each of a plurality of other candidates.

16. The system of claim 1, wherein the plurality of preferences include a desired contribution amount which each of the plurality of candidates are to exchange if selected to participate.

17. The system of claim 16, further comprising a plurality of escrow accounts, wherein each of the plurality of escrow accounts are associated with the desired contribution from each of the plurality of candidates

18. The system of claim 1, wherein the item is an investment fund comprising shares of equitable ownership in stock.

19. The system of claim 1, wherein the item is real property comprising shares of equitable ownership in real estate.

20. The system of claim 1, wherein the item is a business venture comprising shares of equitable ownership in a business entity.

21. The system of claim 1, wherein the contribution by each of the number of participants includes shares of private equity.

22. The system of claim 1, wherein the contribution by each of the number of participants includes an intellectual property right.

23. The system of claim 1, wherein the contribution by each of the number of participants includes real property.

24. A method for selecting a subset of participants from a plurality of candidates and a respective amount of a contribution associated with each participant, where the respective amount of the contribution is exchanged for an equitable ownership interest of an item by each of the subset of participants, the method comprising:
receiving a plurality of preferences associated with each of the plurality of candidates;
receiving a plurality of parameters; and
choosing the subset of participants, wherein the subset of participants are determined according to the plurality of preferences and the plurality of parameters.

25. The method of claim 24, wherein choosing the subset of participants further comprises:
defining an objective having a value representing an optimal combination, the optimal combination representing a best solution;
determine a first fitness value associated with a first possible combination; and
evaluating the first fitness value against the objective value to determine whether the first possible combination associated with the first fitness value is the optimal combination.

26. Method of claim 25, further comprising:
generating a population of a number of possible combinations of subset participants;
selecting the first and a second possible combinations from the population;
forming a new combination from the first and the second possible combinations by crossing-over a first portion from the first possible combination and a second portion from the second possible combination;
evaluating a new fitness value against the objective value to determine whether the new possible combination associated with the new fitness value is the optimal combination,
wherein a fitness value is based upon the strength score and the mutual respect score of the associated combination.

27. Method of claim 26, wherein generating the new combination from the first and the second possible combinations further comprises mutating either of the first or the second possible combinations.

28. A voting system for determining a selected subset of participants in an investment fund, each participant having an equitable ownership interest of the investment fund in exchange for a contribution of stock, the system comprising:
a plurality of candidate computing devices associated with at least one of a plurality of candidate investors configured to communicate a plurality of preferences of each of the plurality of candidate investors;
a networked communication system configured to convey the plurality of candidate computing devices for communicating the plurality of preferences; and
a processing platform configured to communicate via the networked communication system with the plurality of candidate computing devices, the processing platform including a fund manager computing device, a fund manager server and a fund manager database, where the fund manager computing device, the fund manager server and the fund manager database are cross-coupled to each other,
wherein the processing platform selects participants to form the investment fund based upon the plurality of preferences and at least one of the parameters and maintains and updates a plurality of accounts comprising the investment fund in response to an event.

29. The system of claim 28, further comprising an escrow server, wherein the escrow server maintains data representing a number of stock shares is configured to transfer all or less than the number of stock shares to the processing platform after the processing platform selects participants in the investment fund.

30. A method of selecting a subset of participants in an investment fund from a plurality of candidate investors, each of the plurality of candidate investors associated with a contribution, wherein the method employs a voting system comprising at least one candidate computing device associated with at least one of the candidate investors electronically coupled to a fund manager processing platform via a networked communication system, the method of selecting participants comprising:
presenting a plurality of options to each of a plurality of candidate computing devices associated with each of a plurality of candidate investors;
entering a plurality of preferences into the at least one candidate computing device by the at least one of the plurality of candidate investors;
communicating the plurality of preferences between each of the plurality of candidate computing devices and the fund manager processing platform via the networked communication system;
receiving the plurality of preferences into the fund manager processing platform;
providing a plurality of parameters to the fund manager processing platform to govern which of the plurality of candidate investors are to be included in a subset of investment fund participants;
generating the investment fund, the fund including a combination of the contributions from each of the subset of investment fund participants, where each of the subset of investment fund participants receives an equity ownership interest in exchange for the contribution,
wherein the plurality of preferences and the plurality of parameters are used to select which of the plurality of candidate investors are to be included in the subset of investment fund participants and to determine a pro rata equitable ownership interest for each of the subset of investment fund participants.

31. The method claim 30, wherein generating the investment fund further comprising determining a degree of strength associated with each one of the candidate investors, wherein the degree of strength is based upon a number of votes each one of the candidate investors receives from each of a plurality of the other candidate investors.

32. The method claim 30, further comprising determining a degree of mutual respect associated with each of the plurality of the candidate investors selected to participate, wherein the degree of mutual respect between each of the plurality of the candidate investors selected to participate is based upon a number of votes exchanged between two or more of the participant investors.

33. The method claim 30, further comprising determining a degree of diversity associated with each of the plurality of the candidate investors amongst the plurality of the other candidate investors, wherein the degree of diversity is based upon a diversification range having a minimum share level and a maximum share level, where each level is expressed as a percentage of a total fund value.
